(19) United States
(12) Patent Application Publication
(10) Pub. No.: US 2022/0090694 A1
(43) Pub. Date: Mar. 24, 2022

(54) ANTI-SIPHON MECHANISM OF MINIATURE WATER PUMP, AND MINIATURE WATER PUMP

(71) Applicant: SHENZHEN DEYUXIN TECHNOLOGY CO., LTD., Shenzhen (CN)

(72) Inventors: Shouyuan ZHOU, Shenzhen (CN); Lianghui LAI, Shenzhen (CN)

(73) Assignee: SHENZHEN DEYUXIN TECHNOLOGY CO., LTD., Shenzhen (CN)

(21) Appl. No.: 17/542,117

(22) Filed: Dec. 3, 2021

Related U.S. Application Data
(63) Continuation of application No. PCT/CN2020/094428, filed on Jun. 4, 2020.

(30) Foreign Application Priority Data
Jun. 4, 2019 (CN) 201920832749.0

(51) Int. Cl. F16K 24/02

(52) U.S. Cl. CPC F16K 24/02

(57) ABSTRACT

An anti-siphon mechanism of a miniature water pump includes an upper cover and a valve plate mounted below the upper cover. A side surface of the upper cover is penetrated with a water outlet, the upper cover is further provided with an air outlet and a water inlet, the valve plate is provided with an anti-siphon mechanism, the anti-siphon mechanism comprises air distribution chambers arranged on the valve plate, partition areas are arranged between the air distribution chambers, and an air outlet chamber, a water inlet chamber and a water outlet chamber are formed through the partition areas, a valve body device is installed in the air outlet chamber, and a flow stop device is installed in the water outlet chamber.

### CROSS-REFERENCE TO RELATED APPLICATIONS

The present disclosure is a continuous application of International Application No. PCT/CN2020/094428, filed on Jun. 4, 2020, entitled “ANTI-SIPHON MECHANISM OF MINIATURE WATER PUMP, AND MINIATURE WATER PUMP”, which claims the priority of Chinese Patent Application No. 201920832749.0 filed with the Chinese Patent Office on Jun. 4, 2019, and entitled “ANTI-SIPHON MECHANISM OF MINIATURE WATER PUMP, AND MINIATURE WATER PUMP”, the entire contents of which are incorporated in this application by reference.

### FIELD

The present application relates to the technical field of miniature water pump equipment, in particular to an anti-siphon mechanism of a miniature water pump and a miniature water pump.

### BACKGROUND

The miniature water pump in the related art is generally composed of a motor, a bottom cover, an eccentric rubber wheel, a connecting rod, a swing frame, a cylinder body, a leather bowl, a valve plate, and an umbrella shape sealing member and an upper cover. The bottom cover is fixed on an end face of an end of the motor with an output shaft. The bottom cover, the cylinder body, the leather bowl, the valve plate and the upper cover are connected in turn, the eccentric rubber wheel is fixed on the output shaft of the motor, the connecting rod is connected between the eccentric rubber wheel and the swing frame, the swing frame is connected with the leather bowl, and the umbrella shape sealing member is located in the upper cover. The upper cover is provided with a water inlet needle which is an injection-molded hardware needle for water inlet, the side surface of the upper cover is further provided with a water outlet run through the upper cover, and the valve plate is provided with a sunken air distribution chamber around the water inlet and the water outlet. A partition area is arranged between the air distribution chamber and the water outlet for forming separate cavities for water inlet and water outlet. However, the traditional miniature pump cannot pump the liquid in a sealed container with vacuum smoothly, and furthermore there will be a siphon phenomenon after the liquid is discharged.

### SUMMARY

To solve the problem above, the present application provides an anti-siphon mechanism of a miniature water pump, solving the problem that the traditional miniature pump cannot pump the liquid in a sealed container with vacuum smoothly, and furthermore there will be a siphon phenomenon after the liquid is discharged.

The present application provides an anti-siphon mechanism of a miniature water pump including an upper cover and a valve plate installed below the upper cover, a side surface of the upper cover is penetrated with a water outlet, the upper cover is further provided with an air outlet and a water inlet, the valve plate is provided with an anti-siphon mechanism, the anti-siphon mechanism includes air distribution chambers arranged on the valve plate, partition areas are arranged between the air distribution chambers, and an air outlet chamber, a water inlet chamber and a water outlet chamber are formed through the partition areas, a valve body device is installed in the air outlet chamber, and a flow stop device is installed in the water outlet chamber.

Optionally, the air distribution chambers are arranged at a side of the valve plate facing the upper cover and around the air outlet, the water inlet and the water outlet of the upper cover, and the air distribution chambers are provided with a groove.

Optionally, the valve body device includes a duckbill valve, a duckbill cover and an umbrella-shaped air inlet one-way valve device, the duckbill valve is installed at a bottom of the upper cover, and the duckbill cover is installed between the duckbill valve and the umbrella-shaped air inlet one-way valve device.

Optionally, the flow stop device includes an elastic device, a flow stop valve, a flow stop cover and an umbrella-shaped liquid outlet valve device installed at a bottom of the upper cover.

Optionally, the bottom of the valve plate is provided with an umbrella sealing member, and the valve plate is installed at a bottom of the upper cover through the umbrella sealing member.

Optionally, a top of the upper cover is provided with a water inlet needle and an air inlet needle, and the water inlet needle and the air inlet needle are inserted into a sealed container arranged above.

Optionally, the upper cover is provided with a filter screen for filtering inlet water impurities and a fixing cover which are arranged inside and at a same side installing the valve plate.

A miniature water pump including the anti-siphon mechanism above and a braking device installed below the anti-siphon mechanism.

Optionally, the braking device includes a cylinder body, a leather bowl, a swing frame and a bottom cover, the cylinder body is installed at a bottom of the anti-siphon mechanism, the leather bowl penetrates through a bottom of the cylinder body and is installed at the bottom of the anti-siphon mechanism, the swing frame is installed inside the bottom cover and on a bottom surface of the cylinder body through the bottom cover, an eccentric wheel is installed under the bottom cover through the swing frame, and a driving device is connected under the eccentric wheel.

Optionally, the driving device is driven by a motor.

Compared with the related art, the present application has a beneficial effect that the anti-siphon structure of the present application makes the air inlet needle and the water outlet needle of the upper cover communicate with the sealed container at the same time, so that the air inlet needle and the water outlet needle interact. In addition, a stop cover, a stop valve and an elastic device are installed inside the valve plate and communicated with the inside of the valve plate. The stop valve relies on the self-resistance of the spring, to stop the siphon phenomenon. The liquid in the sealed container with vacuum can be cyclically pumped out. The present application can automatically replenish air to circulate and pump out the liquid in the sealed container with vacuum, and at the same time alleviate the siphon phenomenon through the function of stopping flow. The miniature water pump with the anti-siphon mechanism solves the problems that the traditional miniature water pump cannot pump out the liquid in the sealed container with vacuum smoothly or the siphon phenomenon occurs after the liquid is discharged.

### DETAILED DRAWINGS OF THE EMBODIMENTS

The present application is further described below with reference to the drawings and embodiments.

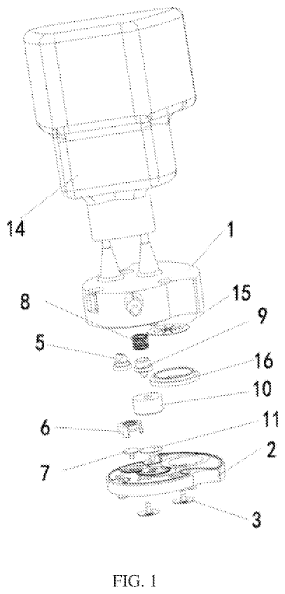

FIG. 1 is a schematic explosion view of an anti-siphon mechanism of a miniature water pump.

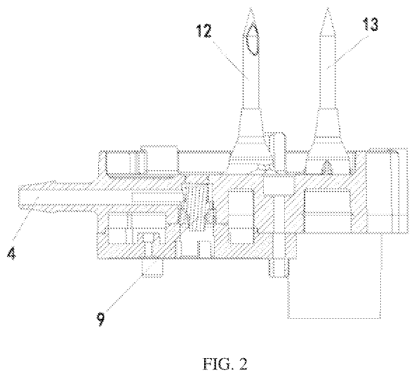

FIG. 2 is a schematic cross-sectional view of the anti-siphon mechanism of the miniature water pump.

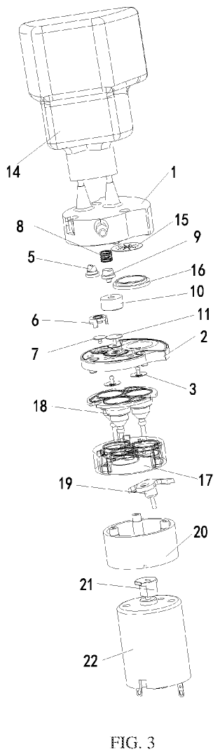

FIG. 3 is a schematic cross-sectional view of the miniature water pump of the present application.

### DETAILED DESCRIPTION OF THE EMBODIMENTS

The present application is described in further detail with reference to the attached drawings. These drawings are simplified schematic views, and only illustrate a basic structure of the present application in a schematic way, so they only show the components related to the present application.

The present application is implemented as: an anti-siphon mechanism of a miniature water pump according to FIGS. 1 to 2, including an upper cover 1 and a valve plate 2 installed below the upper cover 1, a bottom of the valve plate 2 being provided with an umbrella sealing member 3, and the valve plate 2 being installed at a bottom of the upper cover 1 through the umbrella sealing member 3, a side surface of the upper cover 1 being penetrated with a water outlet 4, the upper cover being further provided with an air outlet and a water inlet, an anti-siphon mechanism being arranged in the valve plate 2. The anti-siphon mechanism includes air distribution chambers arranged on the valve plate 2. The air distribution chambers are arranged on a side of the valve plate 2 facing the upper cover 1 and around the air outlet, the water inlet and the water outlet 4 of the upper cover. The air distribution chambers are provided with a groove. Partition areas are arranged between the air distribution chambers, and an air outlet chamber, a water inlet chamber and a water outlet chamber are formed through the partition areas. A valve body device is installed in the air outlet chamber. The valve body device includes a duckbill valve 5, a duckbill cover 6 and an umbrella-shaped air inlet one-way valve device 7. The duckbill valve 5 is mounted at the bottom of the upper cover 1. The duckbill cover 6 is arranged between the duckbill valve 5 and the umbrella-shaped air inlet one-way valve device 7. A flow stop device is arranged in the water outlet chamber, or floating beads are installed in the water outlet chamber. The flow stop device includes an elastic device 8, a stop valve 9, a stop cover 10, and an umbrella-shaped liquid outlet valve device 11 installed at the bottom of the upper cover 1. The elastic device 8 adopts a spring, and a top of the upper cover 1 is provided with a water inlet needle 12 and the water outlet 4, and the water inlet needle 12 and the water outlet 4 are inserted into a sealed container 14 arranged above. The upper cover 1 is installed with a filter screen 15 for filtering out impurities from the inlet water and a fixed cover 16 on the same side of the valve plate 2.

A miniature water pump according to FIG. 3 includes the above-mentioned anti-siphon mechanism and a braking device installed below the anti-siphon mechanism. The braking device includes a cylinder body 17, a leather bowl 18, a swing frame 19 and a bottom cover 20. The cylinder body 17 is installed at a bottom of the anti-siphon mechanism, and the leather bowl 18 penetrates through the bottom of the cylinder body 17 and is installed at the bottom of the anti-siphon mechanism. The swing frame 19 is installed inside a bottom cover 20 and is installed on a bottom surface of the cylinder body 17 through the bottom cover 20. An eccentric wheel 21 is installed below the bottom cover 20 through the swing frame 19, and a lower part of the eccentric wheel 21 is connected with a driving device 22 which is driven by a motor.

A working principle of the present application is described below: when the miniature water pump is working, the driving device 22 drives the eccentric wheel 21 to rotate, the eccentric wheel 21 pushes the swing frame 19 to reciprocate, when the swing frame 19 move downward, a compression chamber changes from a compressed state to an expansion state. Under an action of negative pressure, the umbrella-shaped air inlet one-way valve device 7 is opened by the atmospheric pressure through the duckbill cover 6 provided with small holes. The atmospheric pressure passes through an air inlet groove of the bottom cover 20 and enters a compression chamber of the leather bowl 18. The compression chamber changes from the expansion state to the compressed state. Incoming air opens the umbrella sealing member 3, at the same time the one-way duckbill valve 5 is opened. The air enters the sealed container 14 through the water inlet needle 13, at the same time, the liquid in the sealed container 14 enters the compression chamber through the water inlet needle 13 of the upper cover 1 and then through the valve plate 2. As the swing frame 19 moves upwards, the compression chamber changes from the expansion state to the compressed state. An upper part of the compression chamber closes the valve plate 2 with an umbrella sealing member 3 provided with a water inlet. The umbrella-shaped liquid outlet valve device 7 is opened, at the same time, the flow stop device compresses the elastic device 8 under the water pressure of the water pump itself and the stop valve 9 is opened. The liquid inside the stop valve 19 compresses the leather bowl upward and downward with the up and down movement of the swing frame 19, the liquid enters the stop chamber on the valve plate 2 through the through hole on the valve plate 2, compresses the elastic device 8 in the flow stop device under the water pressure of the water pump itself to open the stop valve 9, and the liquid is discharged from the water outlet 4 of the upper cover 1. When the miniature water pump stops working, the elastic device 8 in the flow stop device is restored to the original extended state, the flow stop valve 9 relies on the self-resistance of the elastic device 8 and restores under the action of the elastic device 8 to reach a sealed state, so that the miniature pump can automatically replenish air to circulate and pump out the liquid in the sealed container with vacuum, and at the same time, the siphon phenomenon is alleviated by having a flow stop function, thus solving the problems that the traditional miniature pump cannot pump out the liquid in the sealed container with vacuum smoothly or that the siphon phenomenon will appear after the liquid is discharged.

It should be noted that names of the water inlet needle 12, the air inlet needle 13 and the water outlet 4 in the present application are for convenience to illustrate and do not limit their functions.

Based on the ideal embodiment of the present application, the skilled of the related art can carry out various changes and modifications without deviating from the technical idea of the present application. The technical scope of the present application is not limited to the contents of the specification but must be determined according to the scope of the present application.

1. An anti-siphon mechanism of a miniature water pump comprising an upper cover and a valve plate installed below the upper cover, wherein a side surface of the upper cover is penetrated with a water outlet, the upper cover is further provided with an air outlet and a water inlet, the valve plate is provided with an anti-siphon mechanism, the anti-siphon mechanism comprises air distribution chambers arranged on the valve plate, partition areas are arranged between the air distribution chambers, and an air outlet chamber, a water inlet chamber and a water outlet chamber are formed through the partition areas, a valve body device is installed in the air outlet chamber, and a flow stop device is installed in the water outlet chamber.

2. The anti-siphon mechanism of claim 1, wherein the air distribution chambers are arranged at a side of the valve plate facing the upper cover and around the air outlet, the water inlet and the water outlet of the upper cover, and the air distribution chambers are provided with a groove.

3. The anti-siphon mechanism of claim 1, wherein the valve body device comprises a duckbill valve, a duckbill cover and an umbrella-shaped air inlet one-way valve device, the duckbill valve is installed at a bottom of the upper cover, and the duckbill cover is installed between the duckbill valve and the umbrella-shaped air inlet one-way valve device.

4. The anti-siphon mechanism of claim 1, wherein the flow stop device comprises an elastic device, a flow stop valve, a flow stop cover and an umbrella-shaped liquid outlet valve device installed at a bottom of the upper cover.

5. The anti-siphon mechanism of claim 1, wherein the bottom of the valve plate is provided with an umbrella sealing member, and the valve plate is installed at a bottom of the upper cover through the umbrella sealing member.

6. The anti-siphon mechanism of claim 1, wherein a top of the upper cover is provided with a water inlet needle and an air inlet needle, and the water inlet needle and the air inlet needle are inserted into a sealed container arranged above.

7. The anti-siphon mechanism of claim 1, wherein the upper cover is provided with a filter screen for filtering inlet water impurities and a fixing cover which are arranged inside and at a same side installing the valve plate.

8. A miniature water pump comprising an anti-siphon mechanism of claim 1 and a braking device installed below the anti-siphon mechanism.

9. The miniature water pump of claim 8, wherein the braking device comprises a cylinder body, a leather bowl, a swing frame and a bottom cover, the cylinder body is installed at a bottom of the anti-siphon mechanism, a bottom of the cylinder body is penetrated by the leather bowl and the leather bowl is installed at the bottom of the anti-siphon mechanism, the swing frame is installed inside the bottom cover and on a bottom surface of the cylinder body through the bottom cover, an eccentric wheel is installed under the bottom cover through the swing frame, and a driving device is connected under the eccentric wheel.

10. The miniature water pump of claim 9, wherein the driving device is driven by a motor.
